(19) United States
(12) Patent Application Publication
(10) Pub. No.: US 2007/0261229 A1
(43) Pub. Date: Nov. 15, 2007

(54) Method and apparatus of producing stator

(76) Inventors: Kazuyuki Yamaguchi, Kariya-shi (JP); Yoshio Kato, Inazawa (JP)

Correspondence Address: MORGAN & FINNEGAN, L.L.P., 3 World Financial Center, New York, NY, 10281-2101, US

(21) Appl. No.: 11/639,972

(22) Filed: Dec. 15, 2006

(30) Foreign Application Priority Data
Dec. 16, 2005 (JP) 2005-362922

(51) Int. Cl. H02K 15/02

(52) U.S. Cl. 29/596; 29/732

(57) ABSTRACT

Using a jig formed by a first holding groove group and a second holding groove group at the outer circumference which is the same in number as the first holding groove group and has the same pitch as the first holding groove group, one side of coils are inserted into the first holding groove group, and the other side of coils are inserted into the second holding groove group. The jig is inserted into the inner circumference of the stator core, the second holding groove group of the jig matches the slot of the stator core, one side of coils is inserted into the corresponding slot of the stator core by a push out device, and the second holding groove group matches the corresponding slot of the stator core, thus positioning the jig, and then inserting the other side of coils into the corresponding slot by the push out device.

### BACKGROUND OF THE INVENTION

1. Field of the Invention

The present invention relates to a method and an apparatus of producing a stator by inserting one side of each of a plurality of prepared coils into the slot of the stator core, inserting the other side of each of the plurality of coils into another slot, and spirally combining the coils as viewed from the one side of the stator core.

2. Description of the Related Art

As a method of producing a stator having a prepared coil can be a method of directly winding wire on the inner teeth of a stator core and a method of inserting a prepared coil into a slot of a stator core.

However, in these methods, only a coil obtained by concentrically winding wire on each magnetic pole can be formed. Therefore, a motor using such a stator core causes a nonuniform torque by a phenomenon in which the density of a circular magnetomotive force is nonuniform. Since the nonuniform torque causes the vibration and noise of a motor, there are various propositions to solve the problems.

A motor capable of conspicuously reducing the nonuniform torque can be formed using a stator (hereinafter referred to as a “spiral coil stator”) obtained by inserting one side of each of a plurality of prepared coils into the slot of the stator core, inserting the other side of each of the plurality of prepared coils into another slot, and spirally combining the coils as viewed from the one side of the stator core.

The obtained stators have short coil ends, their heights are relatively equal, have compact shapes, and are not so nonuniform in torque when they are used in a motor, thereby reducing the vibration and noise of the motor.

However, the above-mentioned spiral coil stator has to be generated by inserting each of both sides of a coil into a slot one by one with another coil overlap each other, and it is hard to mechanically perform the process. Therefore, it is necessary to manually insert a prepared coil into the slot of the stator core, thereby resulting in poor operability in production and high production cost.

On the other hand, as a technique relating to a spiral coil stator, the patent document 1 discloses a method of producing a stator of a motor obtained by sequentially inserting in the direction of the circumference of a stator core a coil piece which is formed in a coil shape and has an inner circumference layer insertion side and an outer circumference layer insertion side into the stator core of the motor in which a plurality of slots having an outer circumference layer and an inner circumference layer, including: a plural wire piece inserting step, as a step of inserting a plural wire coil piece obtained by winding plural turns of a bundle of lead lines of plural fine lines into the slot, of sequentially inserting N plural wire coil piece into the outer circumference layer N pieces distant from the inner circumference layer of the slot in the coil piece insertion order; a single wire piece inserting step, as a step of inserting into the slot after the N-th plural wire coil piece the single wire coil piece obtained by winding plural turns of a single wire line, of inserting the single wire coil piece into the outer circumference layer N pieces distant from the inner circumference layer of the slot; and an interruption inserting step of interruption-inserting the outer circumference layer insertion side of the single wire coil piece after temporarily taking out the inner circumference layer insertion side of the plural wire coil piece from the slot when the outer circumference layer insertion side of the last N single wire coil pieces below the previously inserted inner circumference layer insertion side of the plural wire coil piece.

The patent document 2 discloses a brushless DC motor having a stator coil provided in the slot of the stator by dividing the number of coil lead lines to be prepared at one stage into a plurality of stages.

The patent document 3 discloses a method for producing a multiplayer armature coil for continuously winding a plurality of adjacent in phase coils such that they can be stored in every second slot using 2-layer winding and multiplayer armature coils having the number of slots less than 1 for each phase per pole. After a part of plural layers of continuously wound homopolar coils are stored in the respective slots, at least a part of the coils of other adjacent poles are stored in the slots, and the remaining adjacent continuously wound part or all of coils stored in the slots.

[Patent Document 1] Japanese Published Patent Application No. H10-42528

[Patent Document 2] Japanese Published Patent Application No. H10-28346

[Patent Document 3] Japanese Published Patent Application No. S56-41736

However, in the patent documents 1, 2, and 3 above, the above listed patent documents 1, 2, and 3 do not disclose a method of mechanically performing the operation of inserting a prepared coil into the slot of the stator core, but require manually inserting a coil, and cannot produce a coil at a lower cost on a commercial basis.

### SUMMARY OF THE INVENTION

The present invention aims at providing a method and an apparatus for producing a stator at a low cost on a commercial basis as a spiral coil stator by designing the operation of mechanically and efficiently inserting a prepared coil in a spiral coil stator into a slot of a stator core.

To attain the above-mentioned objective, the method for producing a stator formed by inserting one side of each of a plurality of prepared coils into each slot, and then inserting the other side of each of the plurality of prepared coils into another slot according to the present invention uses a jig having on an outer circumference: a first holding groove group formed by a plurality of slit-shaped holding grooves with pitches of integral multiple pitches of the slot of the stator core; and a second holding groove group formed by the same number of holding grooves as the first holding groove group with the same pitch as the first holding groove group, and includes:

inserting a one side of each of a plurality of prepared coils into the first holding groove group, and the other side of each of the plurality of prepared coils into a holding groove in the second holding groove group adjacent to the holding groove into which one side of each of the plurality of prepared coils is inserted, and arranging each coil along the circumference of the jig;

inserting the jig into the inner circumference of the stator core, pushing out one side of each of the plurality of prepared coils toward the outer circumference by push out device, thereby inserting one side of each of the plurality of prepared coils into a corresponding slot of the stator core; and

rotating the jig with the slot of the stator core, positioning the second holding groove group such that the second holding groove group matches a corresponding slot of the stator core, pushing out the other side of each of the plurality of prepared coils toward the outer circumference by the push out device, and inserting the other side of each of the plurality of prepared coils into a corresponding slot of the stator core.

In the above-mentioned producing method, a plurality of coils can be inserted into a slot with one side of each of the plurality of prepared coils overlapping the other side of each of the plurality of prepared in a spiral form, and a spiral stator core can be mechanically and efficiently produced.

In the above-mentioned producing method, it is desired that overlapped coils are inserted by repeating two or more times the operation of inserting one side of each of the plurality of prepared coils and the other side of each of the plurality of prepared coils into the slots by the jig. According to this aspect of the present invention, a sufficient number of coils can be inserted into the slots by repeatedly performing the operation two or more times although the restrictions on the inner diameter of a stator core, etc. do not allow a sufficient width or length of the holding groove of a jig, and a sufficient number of coils cannot be inserted into the slots in one inserting operation. In addition, since spirally overlapping coils can be inserted as a plurality of layers, coil ends can be more equally shortened.

Furthermore, it is desired that a push out jig obtained by arranging a tabular pusher which narrows toward a tip on the holding groove is used as the push out device, the tip of the pusher of the push out jig is inserted into each of the corresponding holding grooves, the coil inserted into the holding groove is pushed out toward the outer circumference, and inserted into the corresponding slot of the stator core. According to this aspect of the present invention, the sides' of a plurality of prepared coils held in the holding grooves of the jig can be simultaneously inserted into the corresponding slots by inserting and pushing the tip of the pusher of the push out jig into each of the corresponding holding grooves.

It is also desired that a device for generating repulsion by an eddy-current by passing an electric current through a coil is used as the push out device, and the coil is pushed out by the repulsion toward the outer circumference from the holding groove of the jig, and inserting the coil into the corresponding slot of the stator core. According to this aspect of the present invention, the side of a coil can be inserted into a corresponding slot by a simple operation of passing a current through the coil.

Furthermore, it is desired that a device for generating a Lorentz force by passing a current through a coil by generating a magnetic field traversing the holding groove of the jig is used as the push out device, and the coil is pushed out by the Lorentz force toward the outer circumference from the holding groove of the jig, and inserted into the corresponding slot of the stator core. According to this aspect of the present invention, the side of a coil can be inserted into a corresponding slot by a simple operation of passing a current through the coil. For example, one side of each of the plurality of prepared coils can be pressed toward the outer circumference of the jig and the other side of each of the plurality of prepared coils can be pressed toward the inner circumference of the jig, and preventing the other side of each of the plurality of prepared coils from being inserted into the slot.

It is also desired to pass a direct current or an alternating current of a low frequency of 20 Hz or lower through the coil inserted into the slot of the stator core, and press the coil toward the stator core. According to the aspect of the present invention, the inserted coil can be correctly held in the slot.

Furthermore, it is also desired to rotate a jig while pushing one side of each of the plurality of prepared coils toward the stator core and the other side of each of the plurality of prepared coils toward the jig with a direct current or an alternating current at a low frequency of 20 Hz or lower passing through the coil when the jig is rotated with the slot of the stator core after pushing out one side of each of the plurality of prepared coils toward the outer circumference by the push out device and inserting one side of each of the plurality of prepared coils into the corresponding slot of the stator core. According to the aspect of the present invention, since a jig can be rotated with one side of each of the plurality of prepared coils pressed toward the stator core, and the other side of each of the plurality of prepared coils toward the jig, the insulating of a coil wire can be protected against damage between the jig and the stator core.

Additionally, it is also desired to press using a pair of rotation auxiliary jigs each coil end projecting from both end surfaces of the stator core and the jig toward the jig in the axis direction when the jig is rotated with the slot of the stator core after pushing out one side of each of the plurality of prepared coils toward the outer circumference by the push out device and inserting one side of each of the plurality of prepared coils into the corresponding slot of the stator core. According to the aspect of the present invention, the by pressing the coil end toward the jig in the axis direction by the rotation auxiliary jigs, the loop of the coil is enlarged, thereby reducing the force applied to the jig by the enlargement of the coil against the rigidity of the coil when the jig rotates, and preventing the deformation of the jig.

Furthermore, it is desired to insert one by one the side of each of the plurality of prepared coils into each slot in one operation by inserting one side of each of the plurality of prepared coils into every second slot of the stator core and then inserting the other side of each of the plurality of prepared coils into the remaining slot. According to the aspect of the present invention, since the same number of holding grooves as the slots of the stator core can be formed in the jig, the width and the length of the holding groove can be sufficiently set, and the total sectional area of the coil wire that can be held on the holding groove, that is, the total sectional area of the coil wire that can be inserted into the slots of the stator core in one operation, can be increased relatively largely.

Furthermore, when the total sectional area of the coil inserted into the slots of the stator core is Scu, the inner radius of the stator core is Rin, the number of slot is Slot, and the width of the holding groove is d, it is desired that the present invention is applied to the stator core satisfying the equation of Scu>Rin·d-Slot·d²/2π.

According to the aspect of the present invention, the coil wire held in the holding groove of a jig can be easily and correctly inserted into the slot of the stator core.

On the other hand, the apparatus for producing a stator formed by inserting one side of each of the plurality of prepared coils into a slot of a stator core, and then inserting the other side of each of the plurality of prepared coils into another slot according to the present invention includes

a jig having on an outer circumference: a first holding groove group that can be inserted into the inner circumference of the stator core, and formed by a plurality of slit-shaped holding grooves with pitches of integral multiple pitches of the slot of the stator core; a second holding groove group formed by the same number of holding grooves as the first holding groove group with the same pitch as the first holding groove group; and a push out device for inserting one side of each of the plurality of prepared coils and the other side of each of the plurality of prepared coils inserted into the first and second holding groove groups of the jig and held therein into a corresponding slots.

The above-mentioned device is capable of inserting one side of each of a plurality of prepared coils into the first holding groove group of a jig, inserting the other side of each of the plurality of prepared coils into the second holding groove group adjacent to the first holding groove group into which one side of each of the plurality of prepared coils is inserted, arranging each coil along the circumference of the jig, inserting the jig into the inner circumference of the stator core, pushing out one side of each of the plurality of prepared coils toward the outer circumference by push out device, thereby inserting one side of each of the plurality of prepared coils into a corresponding slot of the stator core, rotating the jig with the slot of the stator core, positioning the second holding groove group such that it matches a corresponding slot of the stator core, pushing out the other side of each of the plurality of prepared coils toward the outer circumference by the push out device, and inserting it into a corresponding slot of the stator core, thereby capable of inserting one side of each of the plurality of prepared coils into a slot in such a way that spiral overlapping can be performed, and mechanically and efficiently producing a spiral stator.

According to the present invention, a plurality of coils can be inserted into a slot with one side of each of the plurality of prepared coils overlapping the other side of each of the plurality of prepared coils in a spiral form, and a spiral stator can be mechanically and efficiently produced.

### BRIEF DESCRIPTION OF THE DRAWINGS

FIG. 1 is a perspective view showing a mode for embodying the apparatus for producing a stator according to the present invention;

FIG. 2 is a perspective view showing the state of incorporating the producing apparatus;

FIG. 3 is a plan view showing the state of inserting a jig holding a coil into the inner circumference of a stator core according to a mode for embodying a method for producing a stator according to the present invention;

FIG. 4 is a plan view showing the state of inserting a pusher of a pressure jig into a holding groove of a pertinent and inserting one side of each of the plurality of prepared coils into a slot according to the mode for embodying the present invention;

FIG. 5 is a plan view showing the state of further pushing a pusher and completely inserting one side of each of the plurality of prepared coils into a slot according to the mode for embodying the present invention;

FIG. 6 is a plan view showing the state of extracting the pusher from the state shown in FIG. 5;

FIG. 7 is a plan view showing the state of rotating a jig by predetermined degrees such that the second holding groove holding the other side of each of the plurality of prepared coils can be positioned in a predetermined slot;

FIG. 8 is a plan view showing the state of inputting a pusher into the second holding groove and inserting the other side of each of the plurality of prepared coils into a corresponding slot;

FIG. 9 is a plan view showing the shape of the coil end of the stator obtained according to the mode for embodying the present invention;

FIG. 10 is a side view of the stator;

FIG. 11 is a perspective view of the stator;

FIG. 12 is a schematic chart as a plan view showing another mode for embodying the method for producing the stator according to the present invention;

FIG. 13 is an explanatory view showing as a section the coil charged in the slot of the stator obtained according to the mode for embodying the present invention;

FIG. 14 is a plan view showing the shape of the end surface of the stator obtained according to the mode for embodying the present invention;

FIG. 15 is an explanatory view showing another mode for embodying the method for producing the stator according to the present invention;

FIG. 16 is an explanatory view showing the state of inserting one side of each of the plurality of prepared coils into a slot according to the mode for embodying the present invention;

FIG. 17 is an explanatory view showing another mode for embodying the method for producing the stator according to the present invention;

FIG. 18 is an explanatory view showing the state of inserting one side of each of the plurality of prepared coils into a slot according to the mode for embodying the present invention;

FIG. 19 is an explanatory view showing another mode for embodying the method for producing the stator according to the present invention;

FIG. 20 is an explanatory view showing the state of inserting one side of each of the plurality of prepared coils into a slot according to the mode for embodying the present invention;

FIG. 21 is an explanatory view showing another mode for embodying the method for producing the stator according to the present invention;

FIG. 22 is an explanatory view showing the state of inserting one side of each of the plurality of prepared coils into a slot according to the mode for embodying the present invention;

FIG. 23 is a perspective and explanatory view showing the state of inserting both sides of a coil into the slot of the stator core according to the mode for embodying the present invention;

FIG. 24 is an explanatory view showing a further mode for embodying the method for producing the stator according to the present invention;

FIG. 25 is a plan view including a partially enlarged portion showing a further mode for embodying the method for producing the stator according to the present invention;

FIG. 26 is a plan view including a partially enlarged portion showing the state of inserting one side of each of the plurality of prepared coils into a slot according to the mode for embodying the present invention;

FIG. 27 is a plan view including a partially enlarged portion showing the state of the rotation and the position such that the second holding groove for holding the other side of each of the plurality of prepared coils matches the corresponding slot according to the mode for embodying the present invention;

FIG. 28 is an explanatory view showing the shape of the coil end o the stator core into which the coil is inserted according to the mode for embodying the present invention;

FIG. 29 is an explanatory view used in considering the relationship between the holding groove of a jig and the slot of the stator core;

FIG. 30 is an explanatory view showing the rotation auxiliary jig used in a further mode for embodying the method for producing the stator according to the present invention; and

FIG. 31A is an explanatory view showing the states before pressing the coil end according to the mode for embodying the present invention.

FIG. 31B is an explanatory view showing the states after pressing the coil end according to the mode for embodying the present invention.

### DESCRIPTION OF THE PREFERRED EMBODIMENTS

The mode for embodying the present invention is explained below by referring to the attached drawings.

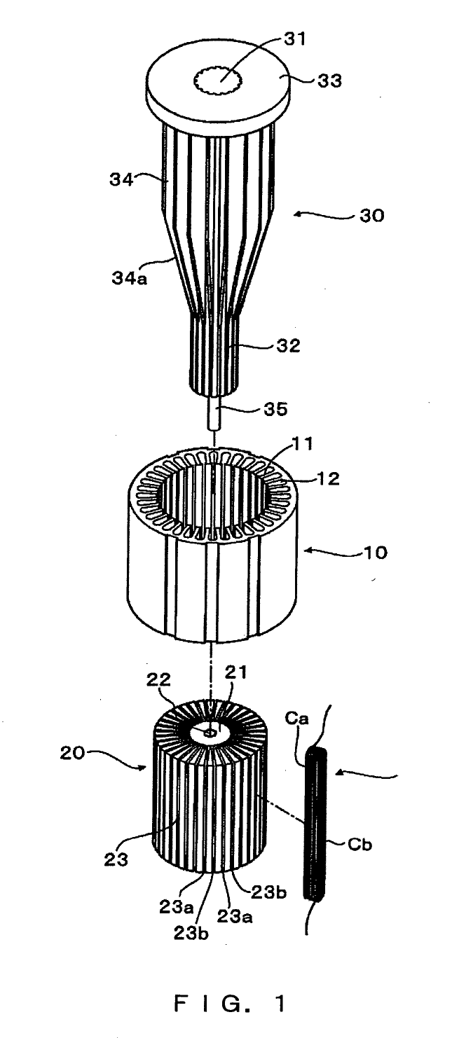

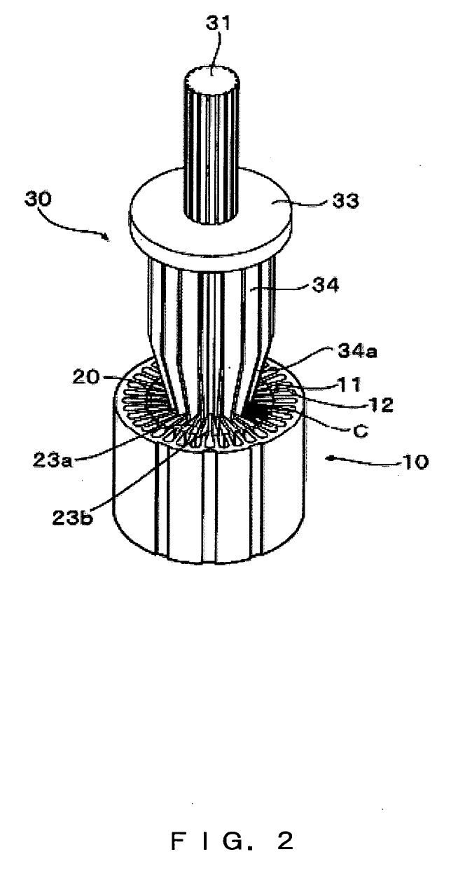

FIGS. 1 and 2 show a mode for embodying the apparatus for producing a stator according to the present invention.

In FIGS. 1 and 2, a stator core 10 has an inner tooth 11 at the inner circumference, and a slot 12 is formed between the inner teeth 11.

The producing apparatus has a substantially cylindrical jig 20 inserted inside the inner circumference of the stator core 10. The jig 20 has a central axis portion 21, a hole 22 provided at the center of the top surface of the axis portion 21, and a plurality of holding grooves 23 radially formed from the outer circumference of the axis portion 21 toward the outer circumference of the cylindrical jig 20. The holding groove 23 has a first holding groove 23a formed with an integral multiple pitch (double pitch according to the present mode for embodying the present invention) of the slot 12 of the stator core 10, and a second holding groove 23b formed between the first holding grooves 23a with the same pitch as the first holding groove 23a.

In this mode for embodying the present invention, the first holding grooves 23a and the second holding grooves 23b are alternately formed at equal intervals, but it means that the pitches of the first holding grooves 23a and the pitches of the second holding groove 23b are integral multiple pitches of the slot 12 of the stator core 10, and the interval between the first holding groove 23a and the second holding groove 23b is not designated. In this mode for embodying the present invention, the holding groove 23 is radially formed from the outer circumference of the axis portion 21 of the jig 20 along the radius of the jig, but the holding groove 23 can be, for example, spirally curved, etc., or tilted relative to the radial array. In this case, the number of coil sides stored in the holding grooves can be increased.

The one side Ca of the coil C is inserted into the first holding groove 23a of the jig 20, and the other side Cb of the coil C is inserted into the second holding groove 23b. The coil C is inserted into the first holding groove 23a and the second holding groove 23b adjacent to each other in the jig 20, and arranged along the circumference of the jig 20.

The producing apparatus has a pressure jig 30 as a push out device for pushing the coil C inserted and held in the first holding groove 23a of the jig 20 into the slot 12 of the stator core 10. The pressure jig 30 has a central axis 31. As the outer circumference of the axis 31, a guide groove 32 along the axis is formed at predetermined intervals along the circumference, the diameter of a lower end 35 of the axis 31 is reduced and inserted into the hole 22 of the jig 20.

A circular body 33 is attached to the outer circumference of the axis 31 such that it can be slid vertically. The circular body 33 has inner teeth to be engaged with the guide groove 32 of the axis 31 at the inner circumference of the circular body 33. At the lower surface of the circular body 33, a plurality of tabular pushers 34 are attached, and each pusher 34 is engaged with the corresponding guide groove 32 of the axis 31, and radially attached to the axis 31. The pusher 34 has a taper portion 34a tapering toward the lower end of. The guide groove 32 of the axis 31 and the pusher 34 are, in this mode for embodying the present invention, formed by the number and at the pitch such that they can be inserted every second slot 12 of the stator core 10.

As shown in FIG. 2, the jig 20 is inserted inside the inner circumference of the stator core 10, and the pressure jig 30 is mounted on the upper portion of the jig 20 with the rotation and the position can be set such that the holding groove 23 of the side portion into which the coil C is to be inserted can be positioned at the corresponding slot 12. That is, the lower end 35 of the axis of the pressure jig 30 is inserted into the hole 22 of the jig 20, and the rotation and the position are set such that the pusher 34 can be positioned at the holding groove 23 that holds the side portion into which the coil C is to be inserted.

In this state, the circular body 33 of the pressure jig 30 is slid downward along the axis 31, each pusher 34 is inserted into the corresponding holding groove 23, the taper portion 34a of the pusher 34 pushes toward the outer circumference the side portion corresponding to the coil C held in the holding groove 23, and inserted into the corresponding slot 12.

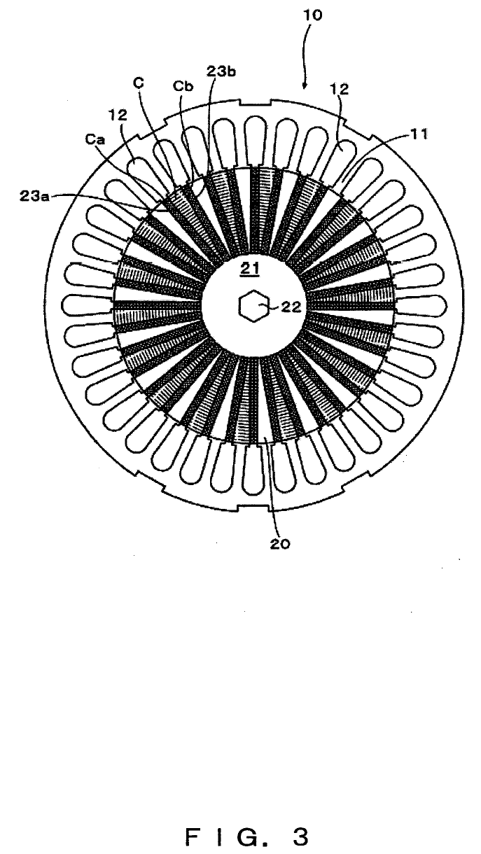

FIGS. 3 to 11 show a mode for embodying the method for producing a stator according to the present invention using the above-mentioned producing apparatus.

As shown in FIG. 3, one side Ca of the coil C is inserted into the first holding groove 23a of the jig 20, and the other side Cb of the coil C is inserted into the second holding groove 23b adjacent to the first holding groove 23a. Thus, a plurality of coils C are arranged along the circumference of the jig 20.

Next, the jig 20 holding the coil C on the holding groove 23 is inserted into the inner circumference of the stator core 10. FIG. 3 shows this state. The rotation and the position of the jig 20 are determined such that each holding groove 23 matches the corresponding slot 12 of the stator core 10. In this state, the pressure jig 30 shown in FIGS. 1 and 2 is mounted above the jig 20, and the rotation and the position are determined such that the pusher 34 matches the first holding groove 23a.

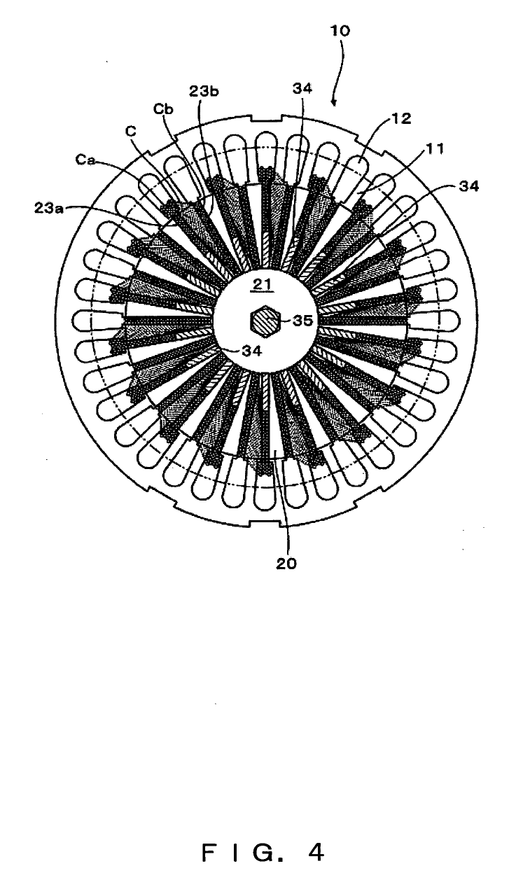

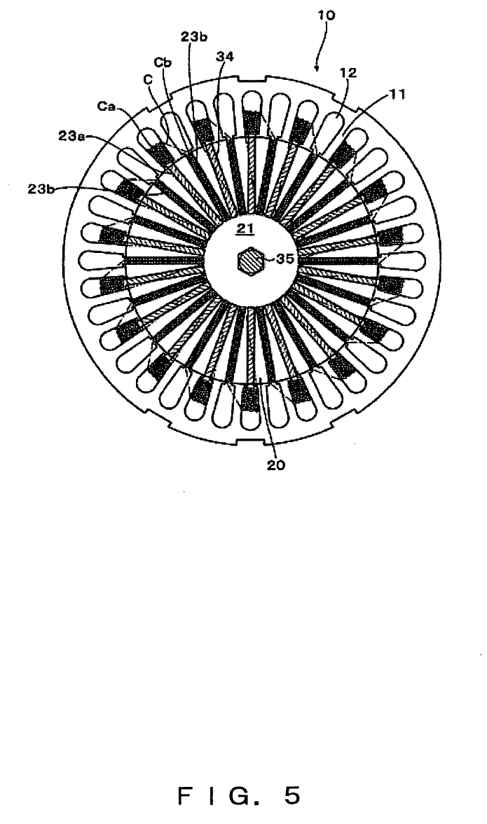

The circular body 33 is slid down on the axis 31, and the pusher 34 is inserted into the first holding groove 23a from the lower end. Then, as shown in FIG. 4, the one side Ca of the coil C inserted into the first holding groove 23a is pushed by the taper portion 34a of the pusher 34 toward the outer circumference and inserted into the slot 12 of the stator core 10. FIG. 5 shows the state in which the one side Ca of the coil C is completely inserted into the slot 12.

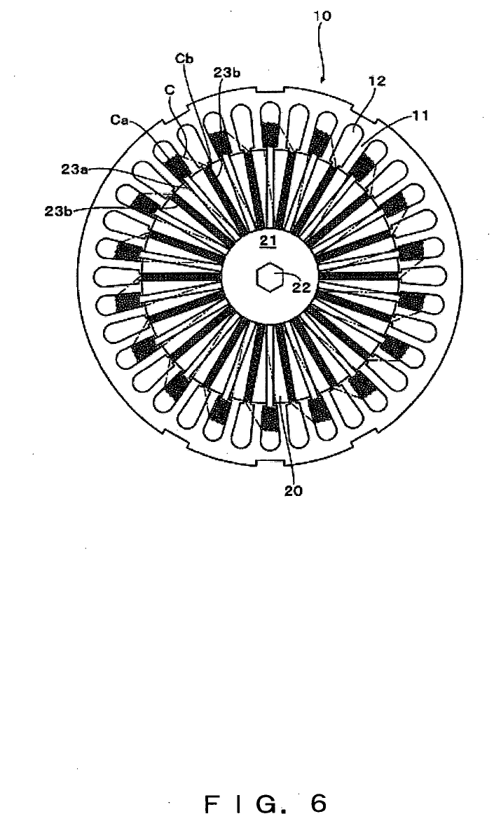

Then, as shown in FIG. 6, the circular body 33 of the pressure jig 30 is pulled up to pull up the pusher 34 from the first holding groove 23a. The subsequent operations can be performed with the pressure jig 30 set above the jig 20, but the pressure jig 30 can be removed from the jig 20.

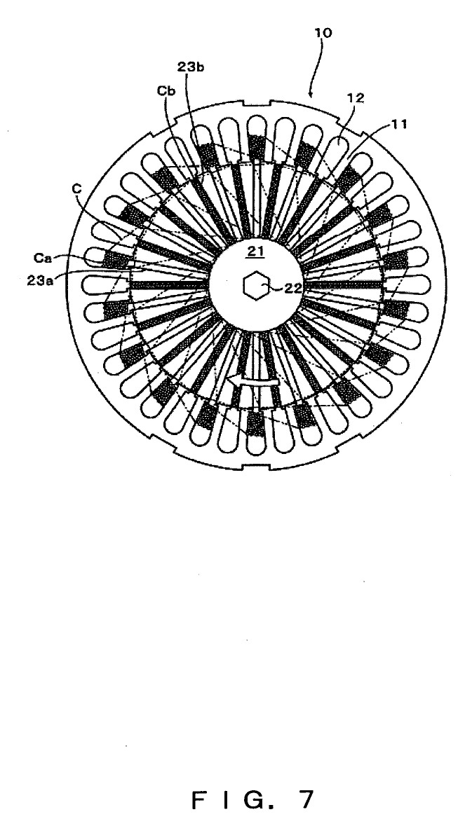

Thus, after pulling out the pusher 34, the jig 20 is rotated by predetermined degrees as shown in FIG. 7, and the rotation and the position are determined such that the other side Cb of the coil C can match the fifth slot 12 ahead from the slot 12 into which the one side Ca is inserted.

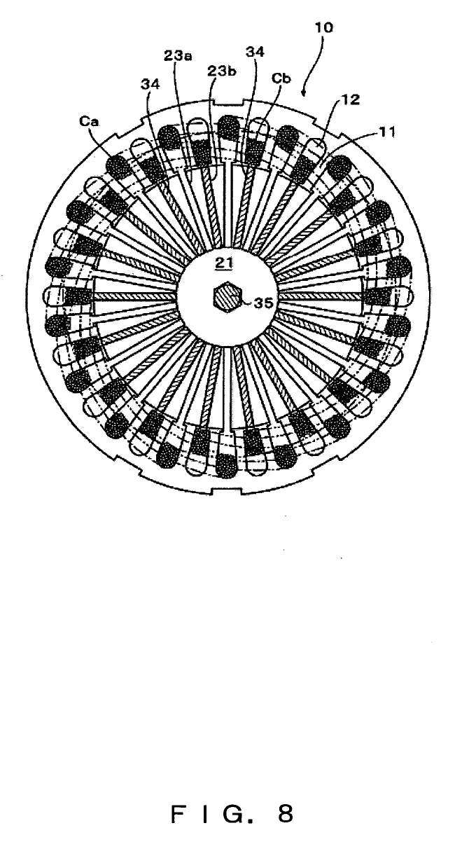

Then, as shown in FIG. 8, the pusher 34 is rotated and positioned to match the second holding groove 23b, and the circular body 33 is slid downward on the axis 31, and the pusher 34 is inserted into the second holding groove 23b from the lower end portion. As a result, the other side Cb of the coil C inserted into the second holding groove 23b is pushed out toward the outer circumference and inserted into the slot 12.

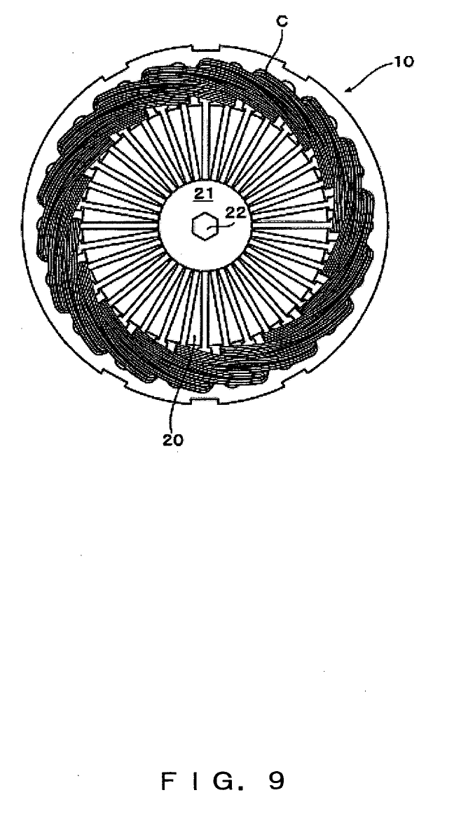

Thus, the one side Ca of the coil C is inserted into one slot 12, and the other side Cb of the coil C is inserted into the fifth slot 12 ahead from the slot 12. Since the inserting operation is performed simultaneously on a plurality of coils C, the coils C are inserted such that the coil ends look spiral from the end surface of the stator core 10 as shown in FIG. 9.

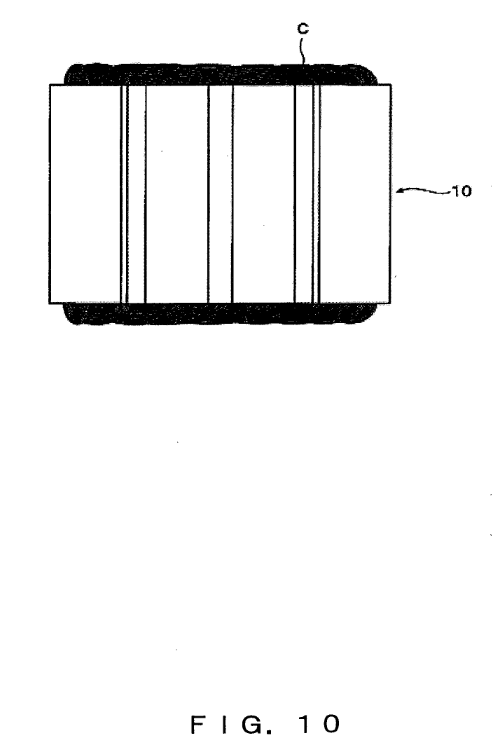

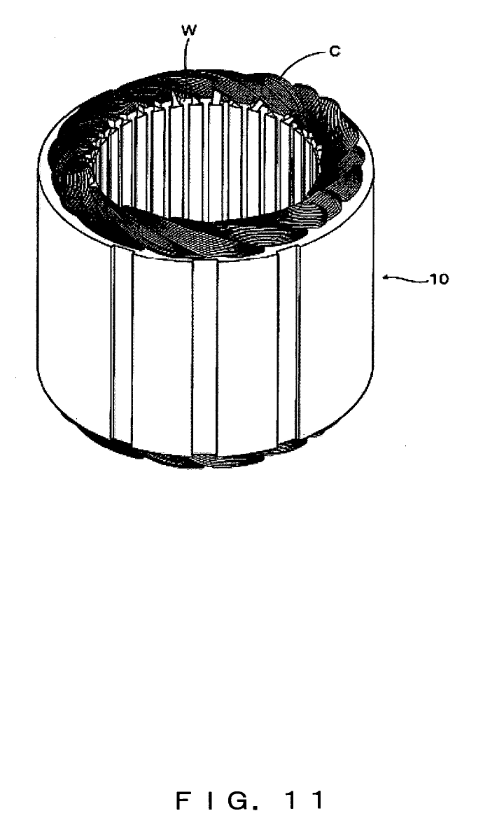

FIG. 10 is a side view of the produced stator core. FIG. 11 is a perspective view of the stator core. Thus, the coil end as a projection portion of the coil C from both end surfaces of the stator core 10 is relatively low in height and equal over the circumference.

After the one side Ca of the coil C held by the jig 20 is inserted, the jig 20 is rotated and positioned, and the other side Cb is inserted. Therefore, the coil C is appropriately expanded in the direction of the circumference and inserted. Furthermore, unlike the method of inserting a coil from one end of a normal stator core to the other end, the coil C is inserted from the inner circumference toward the inner tooth 11 of the stator core 10. Therefore, the coil C is appropriately expanded in the direction of the circumference and inserted. As a result, the coil end can be reduced.

Since the stator core is arranged in the direction of the circumference with each coil C partially overlapping each other, the nonuniform cogging torque can be considerably reduced in a motor, thereby conspicuously decreasing the vibration and noise. Furthermore since the coil end can be compact and can evenly project, a compact stator core 10 and a compact motor using the stator core 10 can be realized.

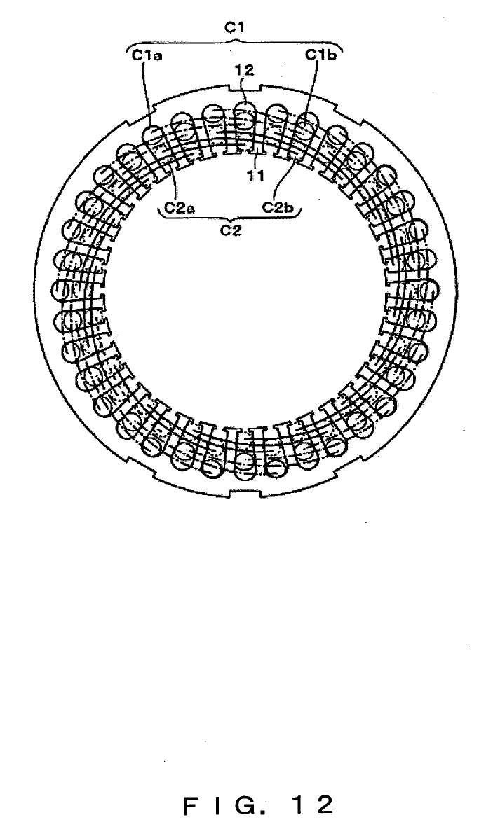

FIGS. 12 through 14 show another mode for embodying the stator producing method according to the present invention. In this producing method, the producing step according to the mode for embodying the present invention is repeated twice. That is, in each slot 12 of the stator core 10, the one side C1a or the other side C1b of the coil C1 inserted in the first step is inserted into the outer circumference of the slot 12, and the one side C2a or the other side C2b of the coil C2 inserted in the second step is inserted into the inner circumference of the slot 12. That is, the one sides C1a and C2a of the coils C1 and C2 are inserted as overlapping each other inside and outside into the slot 12 into which a coil is inserted from the first holding groove 23a of the jig 20, and the other sides C1b and C2b of the coils C1 and C2 are inserted as overlapping each other inside and outside into the slot 12 into which a coil is inserted from the second holding groove 23b.

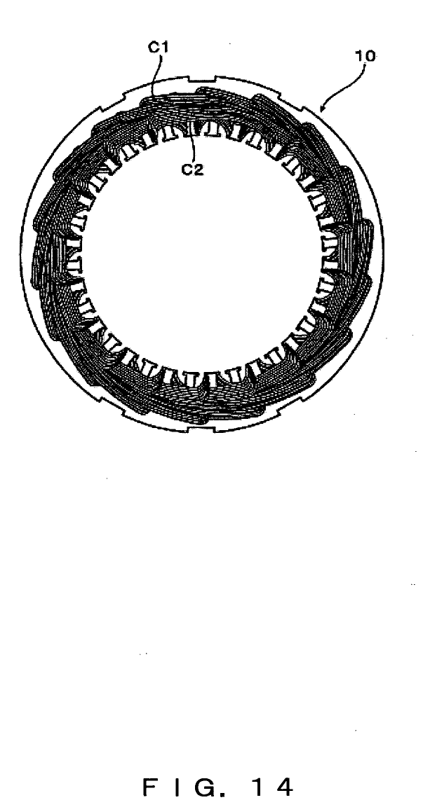

Thus, in the formed stator core, as shown in FIGS. 12 and 14, the coil end of the coil C1 inserted in the first step is spirally formed at the outer circumference, and the coil end of the coil C2 inserted in the second step is also spirally formed at the inner side, thereby forming a double spiral structure.

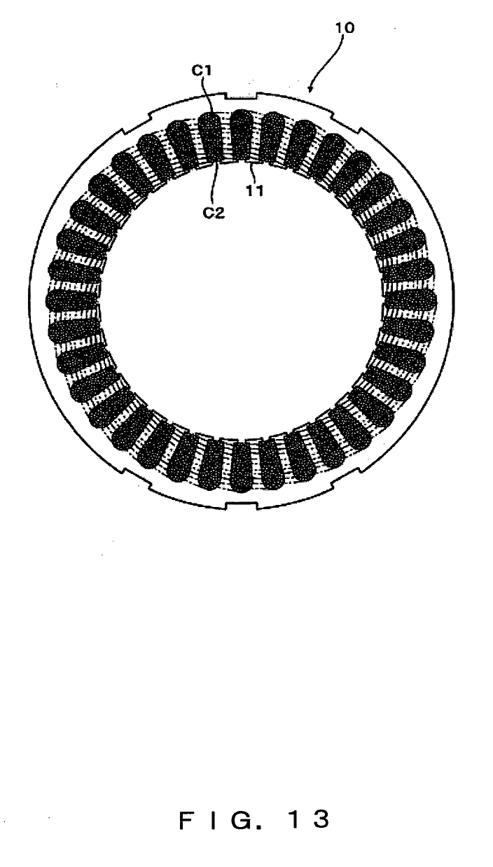

In this method, although a sufficient amount of coils C cannot be inserted and held in inserting one slot 12 into the holding groove 23 of the jig 20, a sufficient amount of coils C can be inserted as shown in FIG. 13 by repeating twice the inserting operation. The frequency of the inserting operation is not limited to twice, but can also be repeated three times or more.

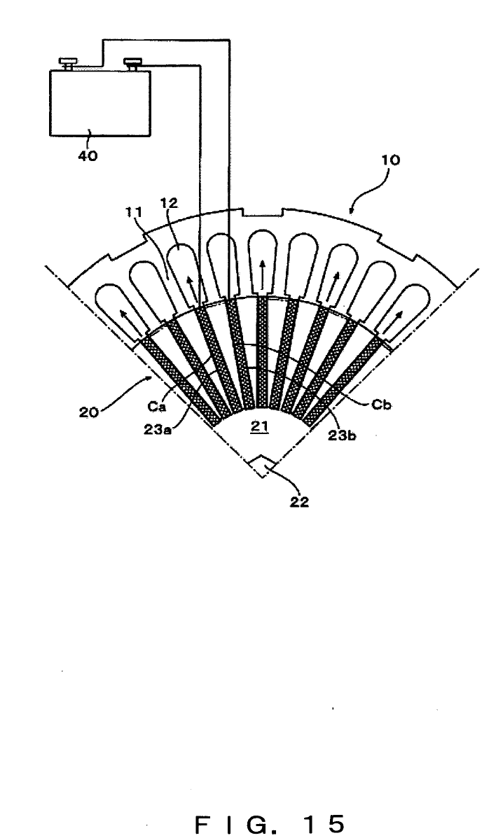

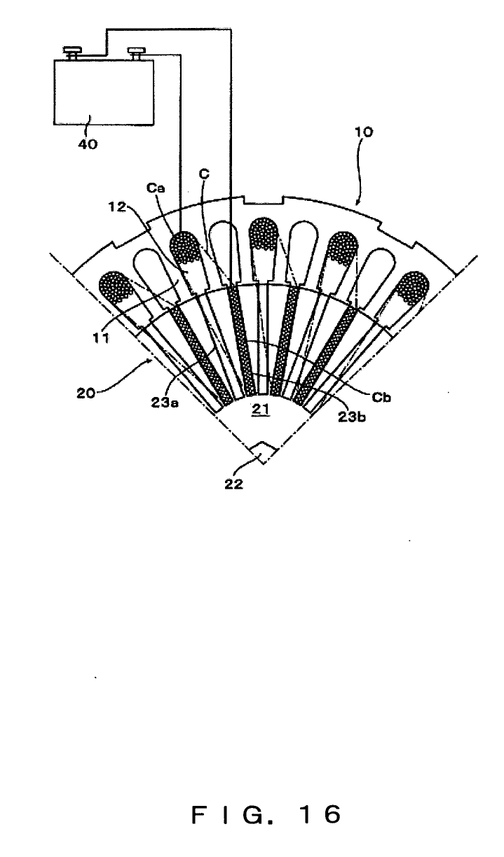

FIGS. 15 and 16 show another mode for embodying the present invention by changing the push out device of the coil C in the above-mentioned producing method.

In this mode for embodying the present invention, the jig 20 is formed by a nonmagnetic substance such as aluminum, the power supply 40 is connected to both ends of the coil C, and an electric current is passed through the coil inserted onto the holding groove 23 of the jig 20 and held therein. In the state shown in FIG. 15, a stopper not shown in the attached drawings is provided at the exit of the second holding groove 23b for the other side Cb of the coil C inserted into the second holding groove 23b so that the other side Cb cannot be pushed out toward the outer circumference. In this state, if a sudden transient current is passed through the coil C, the repulsion by the eddy-current works and causes the effect of the force to push out the coil C toward the outer circumference.

As a result, as shown in FIG. 16, the one side Ca of the coil C is inserted into the corresponding slot 12. Then, the current is stopped, the jig 20 is rotated by predetermined degrees for the stator core 10, and the other side Cb of the coil C is rotated and positioned such that it can be located at a predetermined slot, for example, the fifth slot 12 ahead from the current position. Then, the stopper of the second holding groove 23b is released, and the current is passed through the coil C as described above, thereby inserting this time the other side Cb into the corresponding slot 12. Thus, since a coil can be pushed out toward the outer circumference only by passing an electric current, the structure of the producing apparatus can be simplified, and the coil can be quickly inserted.

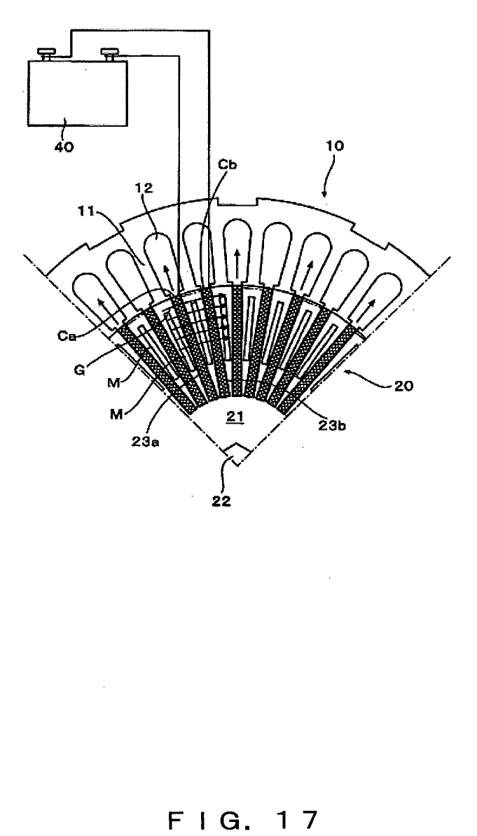

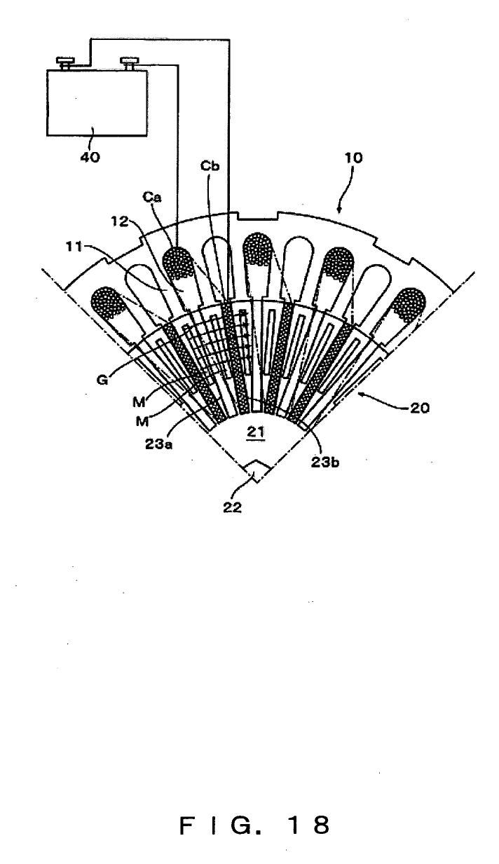

FIGS. 17 and 18 show another mode for embodying the present invention with a push out device changed in the producing method according to the present invention.

In this mode for embodying the present invention, a permanent magnet M is embedded in the radial partition positioned between the holding grooves 23 of the jig 20, and the permanent magnet M forms a circular magnetic field G across the holding groove 23. In this state, when the current passes through the coil C from a power supply 40, a Lorentz force works, at one side of each of the plurality of prepared coils, a push out force is generated toward the outer circumference, and at the other side of each of the plurality of prepared coils, a push out force toward the inner circumference is generated.

In the state shown in FIG. 17, a push out force is exerted on the one side Ca of the coil C toward the outer circumference, and a pressure force is exerted on the other side Cb of the coil C toward the inner circumference. As a result, as shown in FIG. 18, the one side Ca of the coil C is inserted into a corresponding slot 12, and the other side Cb is inserted into the second holding groove 23b.

Thus, after inserting the one side Ca of the coil C into the slot 12, the jig 20 is rotated by predetermined degrees against the stator core 10, and the second holding groove 23b into which the other side Cb of the coil C is inserted is rotated to positioned at a predetermined slot.

As described above, after the second holding groove 23b is arranged at a predetermined slot, the switch of the power supply 40 is switched to inversely pass a current. The push out force is exerted on the other side Cb of the coil C toward the outer circumference, and the coil Cb is inserted into the corresponding slot 12.

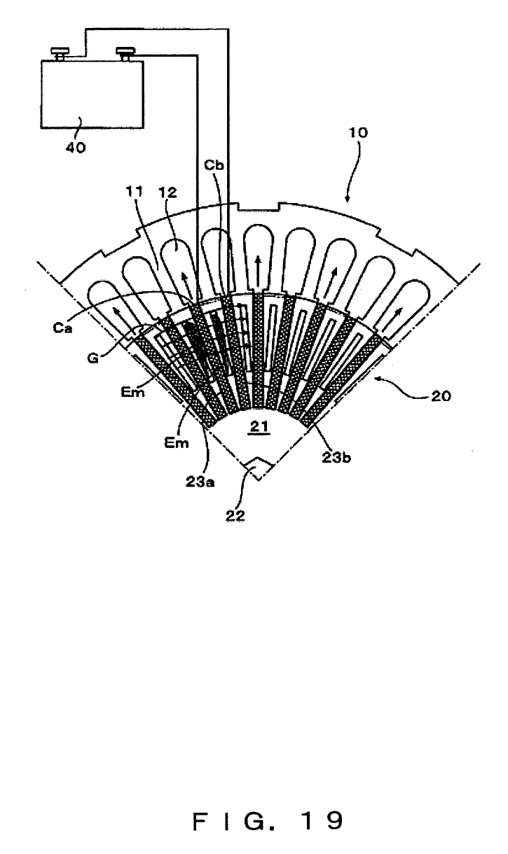

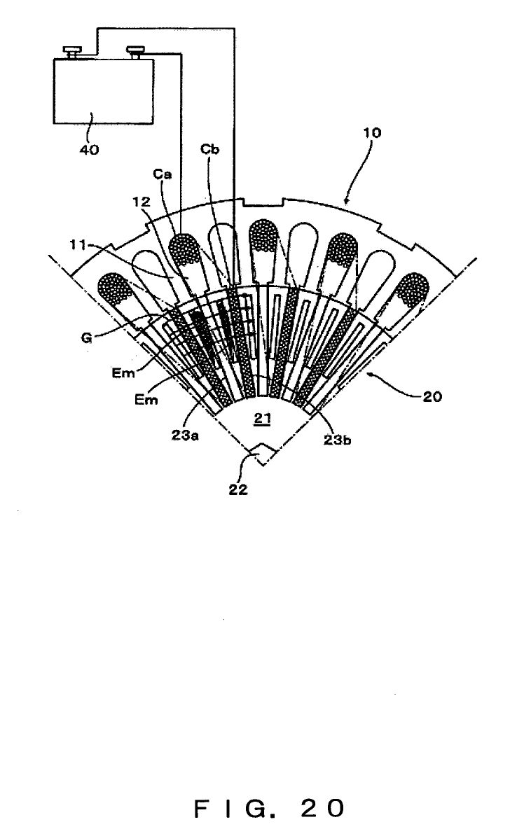

FIGS. 19 and 20 show another mode for embodying the present invention with the push out device changed in the producing method according to the present invention.

This mode is basically the same as the mode shown in FIGS. 17 and 18, but is only different in an electromagnetic Em replaces the permanent magnet M. That is, an insertion groove toward the axis is formed in the partition formed between the holding grooves 23, the electromagnet Em is inserted into the insertion groove, and an electric current is passed through the electromagnet Em from the power supply circuit not shown in the attached drawings, thereby forming a circular magnetic field G across the holding groove 23. Therefore, by passing a current through the coil C in this state, the push out force is exerted toward the outer circumference on one side of the coil C as in the above-mentioned mode, and the pressure force is exerted into the inner circumference on the other side of the coil C. Thus, each coil can be inserted into the slot 12 in the same method as the above-mentioned mode.

Instead of inversely supplying a current to the coil C when inserting the other side Cb into the slot 12 after inserting the one side Ca into the slot 12, the direction of the current passing through the electromagnet Em can be inverted to invert the direction of the magnetic field G.

FIG. 19 shows the state of pushing out the one side Ca of the coil C into the outer circumference. FIG. 20 shows the state in which the one side Ca of the coil C is inserted into the slot 12.

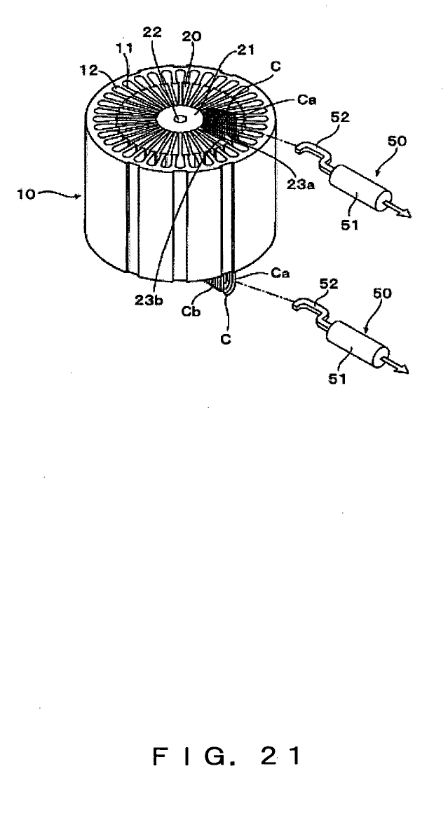

FIGS. 21 through 23 show a further mode for embodying the present invention with the push out device changed in the producing method according to the present invention.

In this mode, a drawing device 50 is used as a push out device for the coil C. The drawing device 50 is provided on both end surfaces of the stator core 10, and has an arm 51 provided as possibly traveling forward and backward near the both end surfaces along the radius, and a hook 52 attached at the tip of the arm 51. Then, the arm 51 is moved toward the inner circumference of the stator core 10, the hook 52 is hung on either side of the coil C, and then the arm 51 is returned toward the outer circumference, thereby drawing the side of the coil C toward the outer circumference. By a pair of drawing devices 50 arranged near both end surfaces of the stator core 10 pulling the side of the coil C toward the outer circumference with the side hung on the hook 52, the coil C can be pushed into the corresponding slot 12 of the stator core 10 from the holding groove 23.

In FIG. 21, only a pair of drawing devices 50 are shown, but actually, a pair of drawing devices 50 are radially arranged at the outer circumference of the stator core 10 corresponding to each coil C. In FIG. 21, only one coil C is shown, but actually, a plurality of coils C are arranged in a line along the circumference of the jig 20.

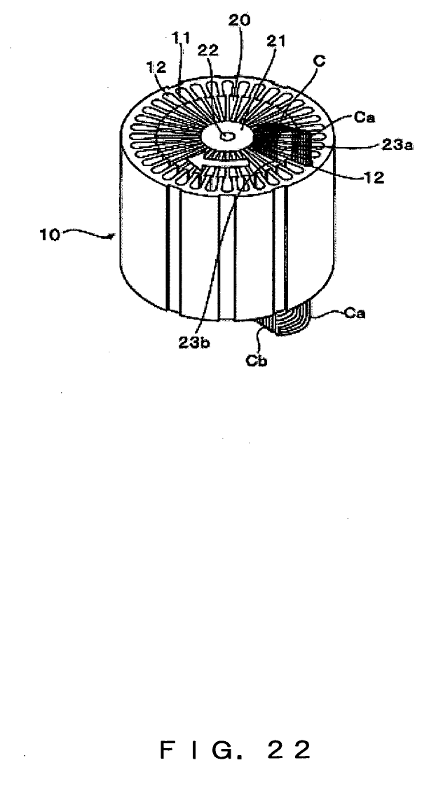

FIG. 22 shows the state in which the drawing device 50 inserts the one side Ca of the coil C into the slot 12. Thus, after the one side Ca of the coil C is inserted into the slot 12, the jig 20 is rotated by predetermined degrees and positioned so that the second holding groove 23b for holding the other side Cb of the coil C can match a predetermined slot 12. In this state, by the drawing device 50 pulling the other side Cb of the coil C toward the outer circumference, the other side Cb of the coil C can be inserted from the second holding groove 23b into the corresponding slot 12.

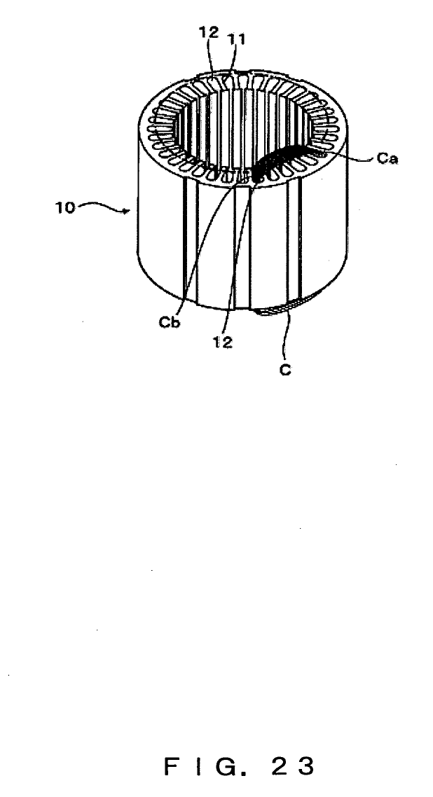

FIG. 23 shows the state in which the both sides Ca and Cb of the coil C are inserted into the corresponding slot 12. In FIGS. 22 and 23, only one coil C is shown, but actually, a plurality of coils C are held in the jig 20, and plural sets of radially arranged drawing devices 50 can simultaneously perform the inserting operation on each coil C.

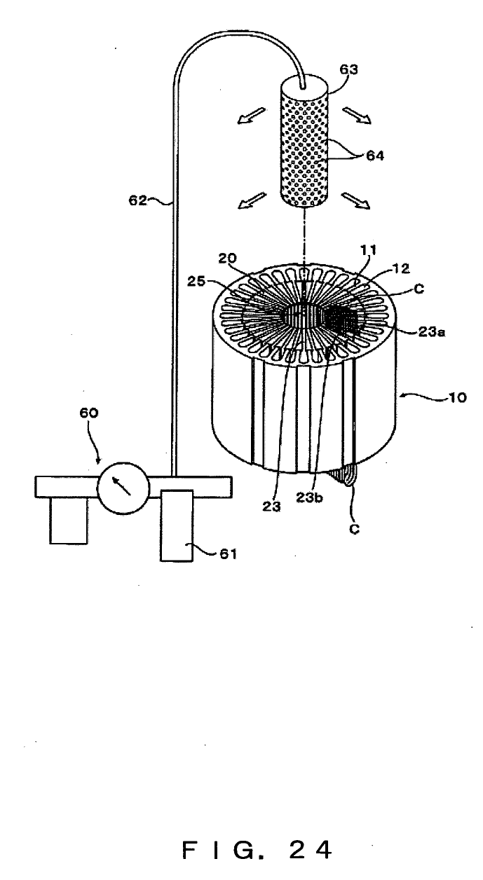

FIG. 24 shows another mode for embodying the present invention with the push out device changed in the producing method according to the present invention.

In this mode for embodying the present invention, an air pressure device 60 is used as a push out device. The air pressure device 60 has an air pressure machine 61 for supplying compressed air, a tube 62 for supplying the air, and a nozzle 63 attached at the tip portion of the tube 62. The nozzle 63 is cylindrical, and a number of spouts 64 are formed on the circumference surface. The jig 20 is provided with a central hole 25. The nozzle 63 is inserted into the hole 25. In the holding groove 23 of the jig 20, a slit-shaped aperture led to the hole 25 is formed at the end portion in the side end portion of the inner circumference. Therefore, by arranging the nozzle 63 in the hole 25 of the jig 20 and supplying compressed air to the nozzle 63 through the tube 62 by the air pressure machine 61, the compressed air is blown from the spouts 64 of the nozzle 63, the compressed air is supplied from the aperture at the inner circumference of the holding groove 23 of the jig 20, and the coil C held in the holding groove 23 is pushed into the predetermined slot 12. The air pressure device 60 can also be used with each of the above-mentioned push out devices.

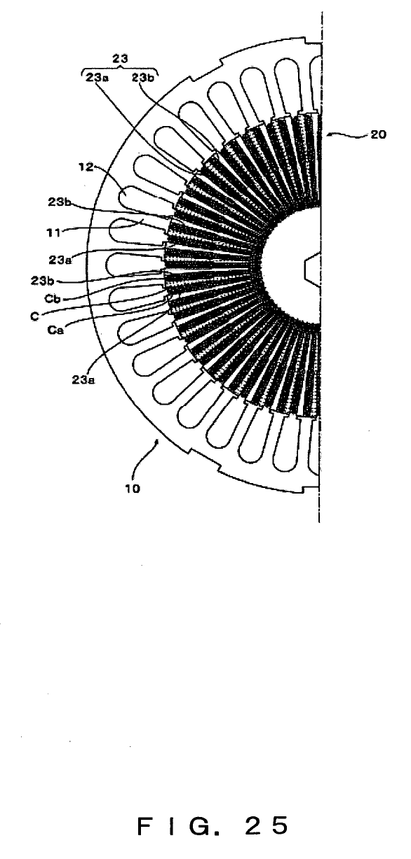

FIGS. 25 through 28 show a further mode for embodying the producing method according to the present invention.

In this mode for embodying the present invention, a set of the first holding groove 23a and the second holding groove 23b of the holding groove 23 of the jig 20 is provided for each slot 12 of the stator core 10. That is, the number of the holding grooves is double the number of those of the jig 20 shown in FIG. 3, etc. That is, the first holding grooves are formed with the pitch of the slot 12. As a result, the intervals of the holding grooves 23 are considerably short inward. Therefore, the width of each groove at the inner circumference of the holding groove 23 is formed narrower than the width at the outer circumference. When the intensity of the jig 20 can be sufficiently reserved, when there can be a smaller number of simultaneously inserted coils C by increasing the number of inserting steps twice or more as shown in FIGS. 12 through 14, when the stator core 10 and the jig 20 are sufficiently large and the intervals can be reserved although the number of holding grooves 23 is doubled, etc. it is not necessary to reduce the width of the groove at the inner circumference of the holding grooves 23. One side Ca of the coil C is inserted into the first holding groove 23a and held therein, and the other side Cb is inserted into the second holding groove 23b adjacent to the first holding groove 23a and held therein. Thus, the same number of the coils C as the slots 12 of the stator core 10 are arranged along the circumference of the jig 20.

FIG. 25 shows the state in which the jig 20 is inserted and arranged inside the inner circumference of the stator core 10, and rotated and positioned such that the first holding groove 23a can match the corresponding slot 12. In this state, using the above-mentioned push out device, for example, the pressure jig 30 shown in FIG. 1, etc. the one side Ca of the coil C held in the first holding groove 23a can be pushed into the corresponding slot 12.

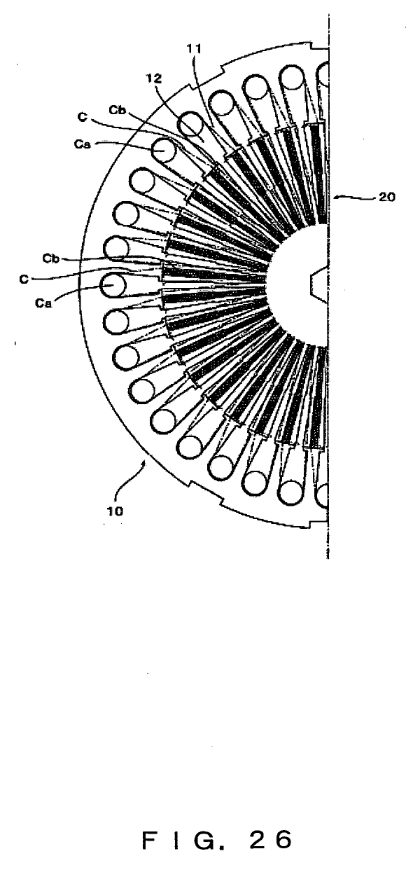

FIG. 26 shows the state in which the one side Ca of the coil C is pushed into each of the corresponding slots 12. That is, one corresponding side Ca of the coil C is pushed into all slots 12 of the stator core 10.

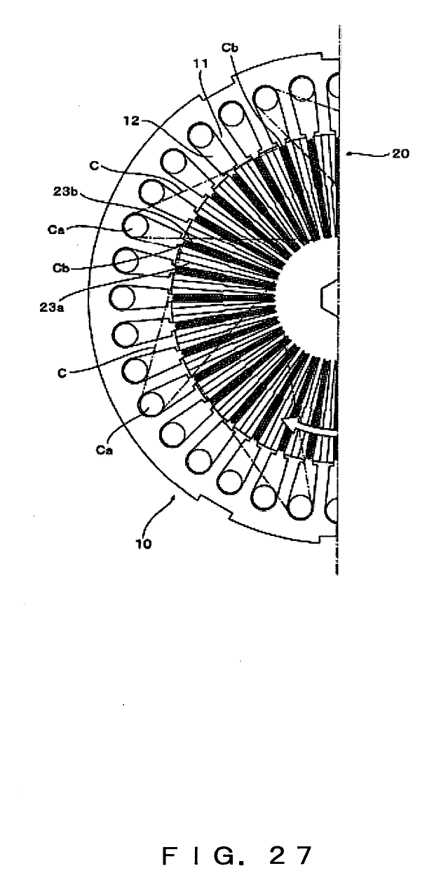

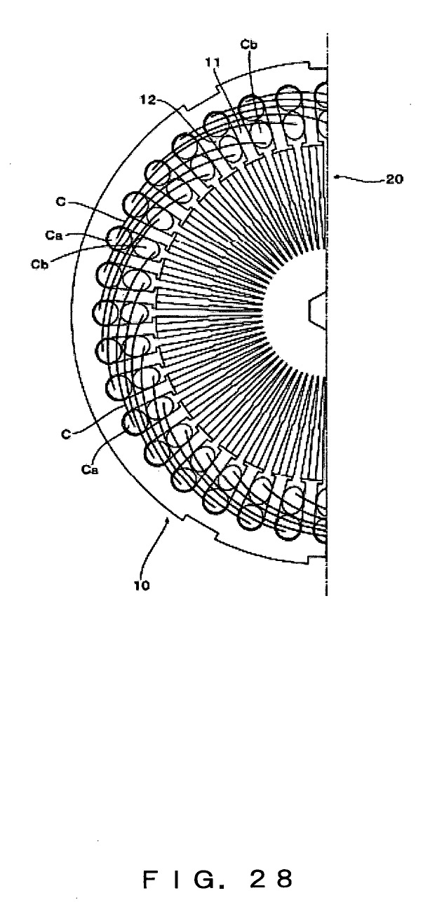

Next, as shown in FIG. 27, the jig 20 is rotated by predetermined degrees, and positioned such that the second holding groove 23b holding the other side Cb of the coil C can match a predetermined slot 12 (in this mode for embodying the present invention, match the slot 12 five slots ahead from the slot into which the one side Ca is inserted). In this state, using the push out device of the pressure jig 30, etc., the other side Cb of the coil C held in the second holding groove 23b is pushed out toward the outer circumference, and inserted into the corresponding slot 12. As a result, as shown in FIG. 28, the one side Ca of the coil C is inserted toward the outer circumference in each slot 12, and the other side Cb of the coil C is inserted toward the inner circumference of the slot 12. Thus, two coils are inserted into one slot 12. In the thus obtained stator core 10, the coil having one side Ca of the coil C positioned on the outer circumference side and the other side Cb positioned on the inner circumference side has coil ends spirally overlapping on the end surface of the stator core 10.

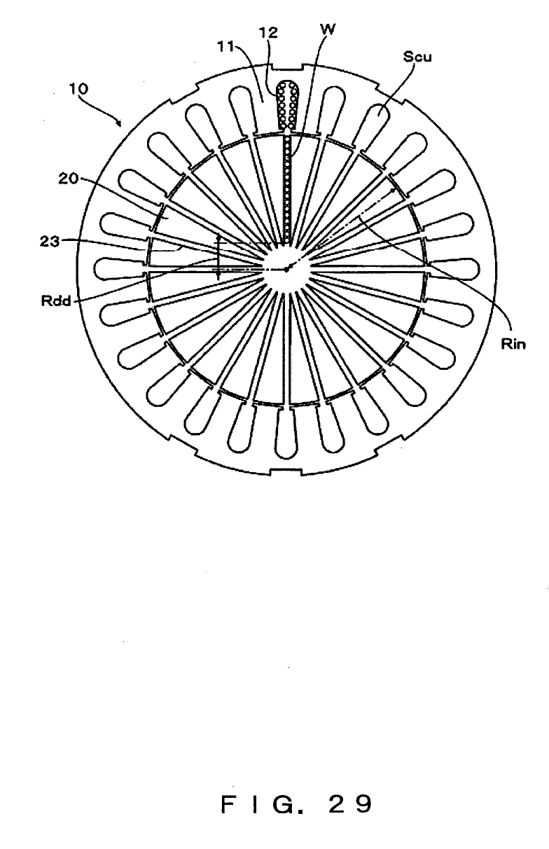

FIG. 29 is an explanatory view for considering the relationships among the total sectional area Scu of the coil C filled in the slot 12, the width d of the holding groove, the number of slots Slot, and the radius Rin in the stator using as a model the case in which the coil line of each coil C is inserted into each holding groove 23 and arranged in a line.

That is, when the line of the coil C is arranged in a line on the holding groove 23 of the jig 20, and inserted into the slot 12 of the stator core 10 from the holding groove 23, and by assuming that the total sectional area of the coils inserted into the slots 12 is Scu, the inner radius of the stator core 10 is Rin, the number of slots is Slot, and the width of the holding groove is d, the following equations 1 and 2 hold.

(when only one coil is inserted into each slot: for example, in the case of the mode for embodying the present invention shown in FIG. 3-11)
Scu>(Rin−Rdd)×d={Rin−(d×Slot/(2π))}×d=Rin·d−Slot·d²/2π [equation 1]
(in the case where two coils are inserted into each slot: for example, in the case of the mode for embodying the present invention shown in FIGS. 25-28)
Scu>(Rin−Rdd)×d×2={Rin−(d×2×Slot/(2π))}×d×2=2·Rin·d−2·Slot·d²/π [equation 2]

Therefore, for the stator core to which the above-mentioned equations can be applied, a line of coils C is arranged for the holding groove 23 of the jig 20, and can be inserted into the slot 12 of the stator core 10 from the holding groove 23, thereby appropriately realizing the producing method according to the present invention.

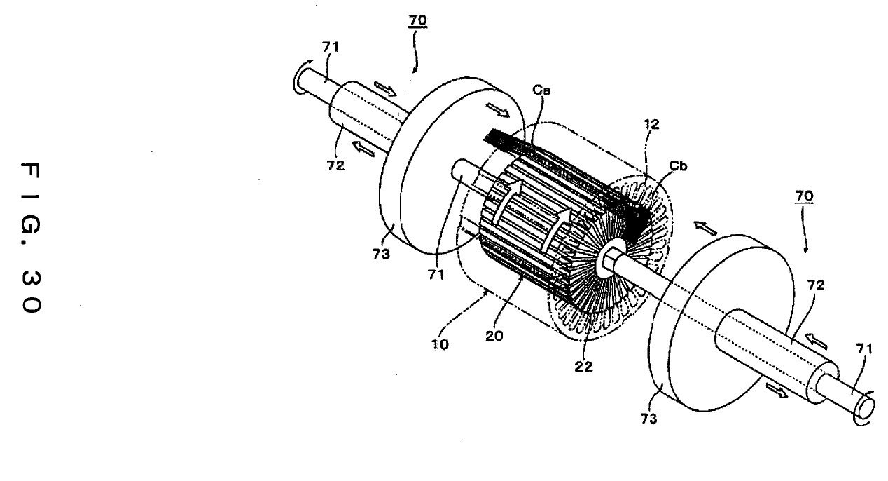

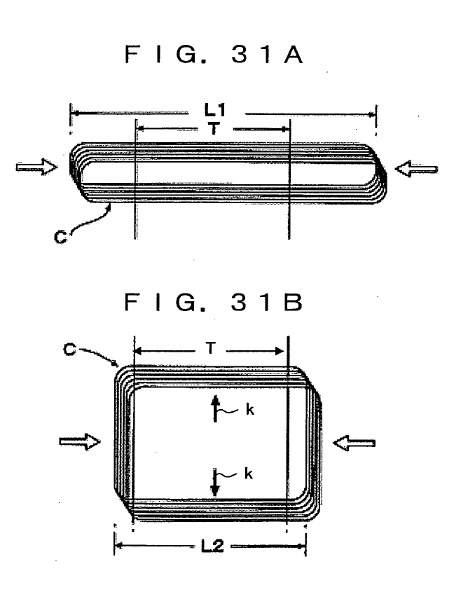

FIGS. 30 and 31 show another mode for embodying the producing method according to the present invention.

In the mode for embodying the present invention, when the one side Ca of the coil C is inserted into the slot 12 of the stator core 10, the jig 20 is rotated by predetermined degrees, and the second holding groove 23b holding the other side Cb is positioned in a predetermined slot 12, the coil ends projecting from both end surfaces of the stator core 10 and the jig 20 are pressed by a pair of rotation auxiliary jigs 70 in the axis direction toward the jig 20.

That is, as shown in FIG. 30, the rotation auxiliary jig 70 has a spindle 71 inserted into the hole 22 of both end surfaces of the jig 20, a cylindrical body 72 attached possibly slid on the spindle 71, and a flange-shaped pressure board 73 attached at the end portion of the cylindrical body 72 faces of the jig 20. By sliding the cylindrical body 72 and the pressure board 73 along the spindle 71 as indicated by the arrow shown in FIG. 30, the coil ends are pressed along the axis.

In FIG. 31, T indicates the thickness of the stator core 10 and the jig 20. FIG. 31A shows the state in which the coil ends of the coil C is not pressed, and the coil C forms a loop extending by the length of L1 in the axis direction of the stator core 10 and the jig 20, thereby long projecting the coil ends. On the other hand, FIG. 31B shows the state in which the pressure board 73 of the rotation auxiliary jig 70 presses the coil ends of the coil C, and the axial length L2 of the coil C in the axial direction of the stator core 10 and the jig 20 is short, and the coil is expanded in the width direction as indicated by the arrows k shown in FIG. 31B.

As a result, when the jig 20 is rotated against the stator core 10 and the loop of the coil C is expanded, the pressure board 73 of the rotation auxiliary jig 70 presses the coil ends, thereby expanding the coil C in the width direction, expanding the coil against the rigidity of the coil C, reducing the force exerted on the jig 20, and preventing the partition portions of the holding grooves 23a and 23b of the jig 20 from being deformed.

In each of the above-mentioned embodiments, the coil C can be held in the slot 12 using the electromagnetic suction. For example, by continuously passing an electric current through the coil C after inserting the one side Ca (C1a, C2a), the one side Ca (C1a, C2a) can be pressed to the stator core 10 as a magnetic substance. In the case of the push out device using the Lorentz force, the electric current is passed in the direction in which the other side Cb (C1b, C2b) does not projected from the second holding groove 23b, or the current through the electromagnet is stopped and remove the magnetic field G when the electromagnet Em is used. Thus, the one side Ca (C1a, C2a) can be more correctly held in the slot 12.

By similarly passing the current continuously through the coil C after inserting the other side Cb (C1b, C2b), the one side Ca (C1a, C2a) and the other side Cb (C1b, C2b) can be correctly held in the slot 12.

By continuously passing the current through the coil C when the jig 20 is rotated and positioned after inserting the one side Ca (C1a, C2a), the electromagnetic suction prevents the one side Ca (C1a, C2a) from projecting from the slot 12 by the force generated by the rotation of the jig 20, and from being pressed between the stator core 10 and jig 20. In the case of the push out device using the Lorentz force, the electric current is passed in the direction in which it does not project from the second holding groove 23b, thereby correctly holding the other side Cb (C1b, C2b) on the second holding groove 23b, preventing the other side Cb (C1b, C2b) from projecting from the second holding groove 23b by the force of the rotation of the jig 20, and then preventing it being pressed between the stator core 10 and the jig 20.

The current passed to generate the electromagnetic suction can be a current whose repulsion by the eddy-current in the coil C can be ignored. For example, it can be a direct current or an alternating current of 20 Hz or less.

In the above-mentioned mode for embodying the present invention, the other side Cb (C1b, C2b) is inserted from the slot into which the one side Ca (C1a, C2a) is inserted into the fifth slot 12 ahead, but the position of the slot is not limited to the fifth.

In FIGS. 12 through 14, the inserting step is performed twice or more when only one coil is inserted into each slot, but the inserting step can be performed twice or more when two coils are inserted into each slot shown in FIGS. 25 through 28.

What is claimed is:

1. A method for producing a stator formed by inserting one side of each of a plurality of prepared coils into each slot, and then inserting the other side of each of the plurality of prepared coils into another slot, comprising:
using a jig having on an outer circumference: a first holding groove group formed by a plurality of slit-shaped holding grooves with pitches of integral multiple pitches of the slot of the stator core; and a second holding groove group formed by the same number of holding grooves as the first holding groove group with the same pitch as the first holding groove group;
inserting a one side of each of a plurality of prepared coils into the first holding groove group, and the other side of each of the plurality of prepared coils into a holding groove in the second holding groove group adjacent to the holding groove into which one side of each of the plurality of prepared coils is inserted, and arranging each coil along the circumference of the jig;
inserting the jig into the inner circumference of the stator core, pushing out one side of each of the plurality of prepared coils toward the outer circumference by push out device, thereby inserting one side of each of the plurality of prepared coils into a corresponding slot of the stator core; and
rotating the jig with the slot of the stator core, positioning the second holding groove group such that the second holding groove group matches a corresponding slot of the stator core, pushing out the other side of each of the plurality of prepared coils toward the outer circumference by the push out device, and inserting the other side of each of the plurality of prepared coils into a corresponding slot of the stator core.

2. The method according to claim 1, wherein
overlapped coils are inserted by repeating two or more times the operation of inserting one side of each of the plurality of prepared coils and the other side of each of the plurality of prepared coils into the slots by the jig.

3. The method according to claim 1, wherein
a push out jig obtained by arranging a tabular pusher which narrows toward a tip on the holding groove is used as the push out device, the tip of the pusher of the push out jig is inserted into each of the corresponding holding grooves, the coil inserted into the holding groove is pushed out toward the outer circumference, and inserted into the corresponding slot of the stator core.

4. The method according to claim 2, wherein
a push out jig obtained by arranging a tabular pusher which narrows toward a tip on the holding groove is used as the push out device, the tip of the pusher of the push out jig is inserted into each of the corresponding holding grooves, the coil inserted into the holding groove is pushed out toward the outer circumference, and inserted into the corresponding slot of the stator core.

5. The method according to claim 1, wherein
a device for generating repulsion by an eddy-current by passing an electric current through a coil is used as the push out device, and the coil is pushed out by the repulsion toward the outer circumference from the holding groove of the jig, and inserting the coil into the corresponding slot of the stator core.

6. The method according to claim 2, wherein
a device for generating repulsion by an eddy-current by passing an electric current through a coil is used as the push out device, and the coil is pushed out by the repulsion toward the outer circumference from the holding groove of the jig, and inserting the coil into the corresponding slot of the stator core.

7. The method according to claim 1, wherein
a device for generating a Lorentz force by passing a current through a coil by generating a magnetic field traversing the holding groove of the jig is used as the push out device, and the coil is pushed out by the Lorentz force toward the outer circumference from the holding groove of the jig, and inserted into the corresponding slot of the stator core.

8. The method according to claim 2, wherein
a device for generating a Lorentz force by passing a current through a coil by generating a magnetic field traversing the holding groove of the jig is used as the push out device, and the coil is pushed out by the Lorentz force toward the outer circumference from the holding groove of the jig, and inserted into the corresponding slot of the stator core.

9. The method according to claim 1, wherein
a direct current or an alternating current of a low frequency of 20 Hz or lower is passed through the coil inserted into the slot of the stator core, and the coil is pressed toward the stator core.

10. The method according to claim 1, wherein
a jig is rotated while pushing one side of each of the plurality of prepared coils toward the stator core and the other side of each of the plurality of prepared coils toward the jig with a direct current or an alternating current at a low frequency of 20 Hz or lower passing through the coil when the jig is rotated with the slot of the stator core after pushing out one side of each of the plurality of prepared coils toward the outer circumference by the push out device and inserting one side of each of the plurality of prepared coils into the corresponding slot of the stator core.

11. The method according to claim 1, wherein
using a pair of rotation auxiliary jigs each coil end projecting from both end surfaces of the stator core and the jig is pressed toward the jig in the axis direction when the jig is rotated with the slot of the stator core after pushing out one side of each of the plurality of prepared coils toward the outer circumference by the push out device and inserting one side of each of the plurality of prepared coils into the corresponding slot of the stator core.

12. The method according to claim 1, wherein
the side of each coil is inserted one by one into each slot in one operation by inserting one side of each of the plurality of prepared coils into every second slot of the stator core and then inserting the other side of each of the plurality of prepared coils into the remaining slot.

13. The method according to claim 12, wherein
when a total sectional area of the coil inserted into the slots of the stator core is Scu, an inner radius of the stator core is Rin, a number of slot is Slot, and a width of the holding groove is d, the method is applied to a stator core satisfying an equation of Scu>Rin·d-Slot·d²/2π.

14. An apparatus for producing a stator by inserting one side of each of a plurality of prepared coils into each slot of a stator core, and then inserting the other side of each of the plurality of prepared coils into another slot, comprising:
a jig capable of being inserted inside an inner circumference of a stator core, and having on an outer circumference: a first holding groove group formed by a plurality of slit-shaped holding grooves with pitches of integral multiple pitches of the slot of the stator core; and a second holding groove group formed by the same number of holding grooves as the first holding groove group with the same pitch as the first holding groove group; and
a push out device inserting one side of each of the plurality of prepared coils and the other side of each of the plurality of prepared coils inserted and held in the first holding groove group and the second holding groove group of the jig into a corresponding slot.
